(19) United States
(12) Patent Application Publication
(10) Pub. No.: US 2025/0210821 A1
(43) Pub. Date: Jun. 26, 2025

(54) BUS BAR MODULE

(71) Applicant: YAZAKI CORPORATION, Tokyo (JP)

(72) Inventors: Katsunori Sato, Makinohara-shi, Shizuoka (JP); Tatsuya Oga, Makinohara-shi (JP); Mariko Nakagawa, Makinohara-shi (JP); Masato Tanaka, Makinohara-shi (JP)

(21) Appl. No.: 18/984,853

(22) Filed: Dec. 17, 2024

(30) Foreign Application Priority Data
Dec. 25, 2023 (JP) 2023-218391

(51) Int. Cl. H01M 50/507; H01M 50/519

(52) U.S. Cl. CPC H01M 50/507; H01M 50/519

(57) ABSTRACT

A bus bar module includes: a plurality of bus bars arranged in an arrangement direction; a flexible printed circuit including a plurality of detection lines connected to the plurality of bus bars; and a device connection unit provided on the flexible printed circuit to connect the plurality of detection lines to an external device, in which a position of the device connection unit in the arrangement direction is between bus bars at both ends. The device connection unit may be positioned in the middle between the bus bars at both ends in the arrangement direction.

### CROSS-REFERENCE TO RELATED APPLICATION(S)

The present application claims priority to and incorporates by reference the entire contents of Japanese Patent Application No. 2023-218391 filed in Japan on Dec. 25, 2023.

### BACKGROUND OF THE INVENTION

### 1. Field of the Invention

The present invention relates to a bus bar module.

### 2. Description of the Related Art

Conventionally, there is a battery sensing unit including a flexible printed circuit. Japanese Patent Application Laid-open No. 2022-108301 discloses a battery sensing unit including a circuit board, a voltage detection unit capable of detecting a voltage value of a battery, and a current detection unit capable of detecting a current value of the battery. The circuit board of Japanese Patent Application Laid-open No. 2022-108301 includes a flexible printed circuit having a conductive pattern.

In a bus bar module, the number of detection lines increases as the number of bus bars increases. Meanwhile, there has been a demand for suppressing an increase of a space for arranging the bus bar module. For example, if the width of the flexible printed circuit can be reduced, it is possible to suppress an increase of the space for arranging the bus bar module.

### SUMMARY OF THE INVENTION

An object of the present invention is to provide a bus bar module capable of reducing a width of a flexible printed circuit.

In order to achieve the above mentioned object, a bus bar module according to one aspect of the present invention includes a plurality of bus bars arranged in an arrangement direction; a flexible printed circuit including a plurality of detection lines connected to the plurality of bus bars; and a device connection unit provided on the flexible printed circuit to connect the plurality of detection lines to an external device, wherein a position of the device connection unit in the arrangement direction is between bus bars at both ends.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a bus bar module according to an embodiment;

FIG. 2 is a plan view of another bus bar module according to an embodiment;

FIG. 3 is a plan view of another bus bar module according to an embodiment; and

FIG. 4 is a plan view of another bus bar module according to an embodiment.

### DETAILED DESCRIPTION OF THE PREFERRED EMBODIMENTS

Hereinafter, bus bar modules according to embodiments of the present invention will be described in detail with reference to the drawings. Note that the present invention is not limited by the present embodiments. In addition, the components in the following embodiments include those that can be easily imagined by those skilled in the art or those that are substantially the same.

### Embodiments

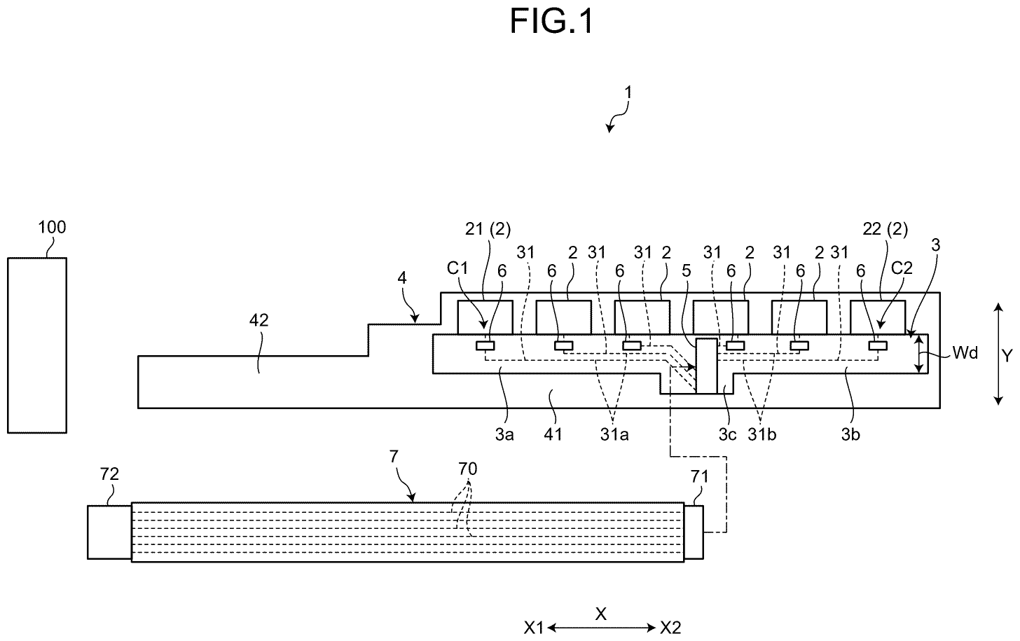

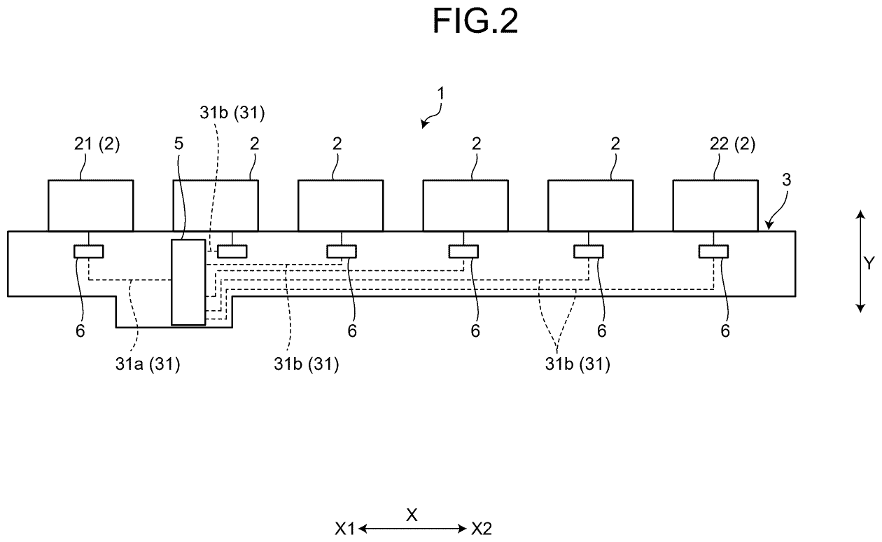

Embodiments will be described with reference to FIGS. 1 to 4. The present embodiments relate to bus bar modules. FIG. 1 is a plan view of a bus bar module according to an embodiment, and FIGS. 2 to 4 are plan views of other bus bar modules according to embodiments.

As illustrated in FIG. 1, a bus bar module 1 of the present embodiment includes a plurality of bus bars 2 arranged in an arrangement direction X, a flexible printed circuit (FPC) 3, a device connection unit 5, and a case 4. The bus bar module 1 is assembled to, for example, a battery module having a plurality of battery cells. The flexible printed circuit 3 includes a base film, a conductive layer, and a cover layer. The conductive layer is sandwiched between and protected by the base film and the cover layer. The conductive layer is, for example, a conductive metal foil, and has a circuit pattern including a plurality of detection lines 31.

The bus bar 2 is a plate-like member formed of a conductive metal. The bus bar 2 is fixed to, for example, an electrode of a battery cell, and electrically connects two battery cells. The bus bar module 1 of the present embodiment includes a plurality of bus bars 2. The plurality of bus bars 2 are arranged at intervals along the arrangement direction X. The arrangement direction X is, for example, a direction in which the battery cells are arranged in the battery module.

The detection line 31 is connected to a bus bar 2 corresponding thereto. The bus bar module 1 of the present embodiment includes a plurality of chip fuses 6 surface-mounted on the flexible printed circuit 3. The detection line 31 is connected to the bus bar 2, for example, via the chip fuse 6.

The device connection unit 5 is provided on the flexible printed circuit 3. The device connection unit 5 connects the plurality of detection lines 31 to an external device 100. The device connection unit 5 is, for example, a connector having a plurality of terminals. Each terminal of the connector is connected to a detection line 31 corresponding thereto. In a case where the device connection unit 5 is a connector, the direction in which the device connection unit 5 and the mating connector are fitted is, for example, the arrangement direction X. In this case, the plurality of terminals included in the device connection unit 5 are arranged, for example, in a width direction Y. The width direction Y is a direction orthogonal to the arrangement direction X when the flexible printed circuit 3 is viewed in a plan view.

The position of the device connection unit 5 in the arrangement direction X is a position between the bus bars 2 at both ends. The plurality of bus bars 2 includes a first bus bar 21 and a second bus bar 22. The first bus bar 21 is a bus bar 2 disposed at an end portion on a first side X1 in the arrangement direction X among the plurality of bus bars 2. The second bus bar 22 is a bus bar 2 disposed at an end portion on a second side X2 in the arrangement direction X among the plurality of bus bars 2.

The bus bar module 1 has a first connection position C1 and a second connection position C2 in the arrangement direction X. The first connection position C1 is a position where a detection line 31 corresponding to the first bus bar 21 is connected to the first bus bar 21. A chip fuse 6 corresponding to the first bus bar 21 is disposed at the first connection position C1. The second connection position C2 is a position where a detection line 31 corresponding to the second bus bar 22 is connected to the second bus bar 22. A chip fuse 6 corresponding to the second bus bar 22 is disposed at the second connection position C2.

The position of the device connection unit 5 in the arrangement direction X is a position between the first connection position C1 and the second connection position C2. That is, the position of the device connection unit 5 is on the second side X2 with respect to the first connection position C1 and on the first side X1 with respect to the second connection position C2.

By disposing the device connection unit 5 as described above, the plurality of detection lines 31 include first detection lines 31a and second detection lines 31b. The first detection lines 31a are detection lines 31 arranged on the first side X1 with respect to the device connection unit 5. The first detection lines 31a extend from the device connection unit 5 toward the first side X1. The first detection lines 31a extend along the arrangement direction X from the device connection unit 5 toward bus bars 2 to be connected thereto. The first detection lines 31a include a detection line 31 connected to the first bus bar 21.

The second detection lines 31b are detection lines 31 arranged on the second side X2 with respect to the device connection unit 5. The second detection lines 31b extend from the device connection unit 5 toward the second side X2. The second detection lines 31b extend along the arrangement direction X from the device connection unit 5 toward bus bars 2 to be connected thereto. The second detection lines 31b include a detection line 31 connected to the second bus bar 22.

In the bus bar module 1 of the present embodiment, some of the bus bars 2 are disposed on the first side X1 with respect to the device connection unit 5, and other ones of the bus bars 2 are disposed on the second side X2 with respect to the device connection unit 5. Therefore, the plurality of detection lines 31 are arranged in a distributed manner on both sides in the arrangement direction X with respect to the device connection unit 5. Therefore, in the bus bar module 1 of the present embodiment, the flexible printed circuit 3 can have a narrow width Wd.

As a comparative example, a bus bar module in which the device connection unit 5 is disposed on the first side X1 with respect to the first bus bar 21 will be considered. In this case, all the detection lines 31 are concentrated at a portion of the flexible printed circuit 3 adjacent to the first bus bar 21. As a result, a width Wd of the flexible printed circuit 3 becomes large. On the other hand, in the bus bar module 1 of the present embodiment, as the detection lines 31 are less likely to be concentrated in one place, the width Wd can be reduced.

In the flexible printed circuit 3 of the present embodiment, a width Wd of a region 3a in which the first detection lines 31a are wired may be set to a minimum value according to the number of first detection lines 31a. A width Wd of a region 3b in which the second detection lines 31b are wired may be set to a minimum value according to the number of second detection lines 31b. A width of a region 3c in which the device connection unit 5 is disposed may be set to a minimum value necessary for the arrangement of the device connection unit 5. In the bus bar module 1 of FIG. 1, at least the regions 3a and 3b can be narrowed.

The bus bar module 1 of the present embodiment includes a wiring member 7 that connects the device connection unit 5 to the external device 100. The wiring member 7 is, for example, a flexible printed circuit. The wiring member 7 includes a plurality of connection lines 70 corresponding to the plurality of detection lines 31. The wiring member 7 is provided with a first connection unit 71 and a second connection unit 72.

The first connection unit 71 is disposed at one end portion of the wiring member 7, and the second connection unit 72 is disposed at the other end portion of the wiring member 7. The first connection unit 71 is connected to the device connection unit 5. In a case where the device connection unit 5 is a connector, the first connection unit 71 is configured as a connector. The second connection unit 72 is connected to the external device 100. The second connection unit 72 is, for example, a connector to be fitted to a connector of the external device 100.

The case 4 accommodates the plurality of bus bars 2 and the flexible printed circuit 3. The case 4 is formed of, for example, an insulating synthetic resin. The case 4 is assembled and fixed to, for example, the battery module. The case 4 includes a first accommodation portion 41 and a second accommodation portion 42. The first accommodation portion 41 accommodates the plurality of bus bars 2 and the flexible printed circuit 3. The first accommodation portion 41 has a substantially rectangular shape. The second accommodation portion 42 accommodates the wiring member 7. The second accommodation portion 42 protrudes from the end of the first accommodation portion 41 toward the first side X1 along the arrangement direction X. The second accommodation portion 42 has a substantially rectangular shape.

For example, the bus bar module 1 is assembled to the battery module in a state where the case 4 holds the bus bars 2 and the flexible printed circuit 3. In this case, the wiring member 7 may be connected to the device connection unit 5 and the external device 100 after the case 4 is assembled to the battery module. The bus bar module 1 may be assembled to the battery module after the wiring member 7 is connected to the device connection unit 5.

The bus bar module 1 of the present embodiment can cope with a battery pack having a high energy density. As the energy density increases in the battery pack, it is necessary to arrange many detection lines 31 in a narrow wiring space. In a case where many detection lines 31 are wired, if the number of conductive layers in the flexible printed circuit 3 increases, the wiring space in the height direction increases. In the bus bar module 1 of the present embodiment, it is possible to narrow the width Wd of the wiring space while suppressing an increase in thickness of the flexible printed circuit 3. Therefore, the bus bar module 1 of the present embodiment can suppress increases in height and width of the space required for wiring the detection lines 31.

In the bus bar module 1 of FIG. 1, the position of the device connection unit 5 in the arrangement direction X is the middle between the bus bars 21 and 22 at both ends. In the bus bar module 1, in a case where the number of bus bars 2 arranged in the arrangement direction X is an even number, the device connection unit 5 may be disposed such that the number of first detection lines 31a and the number of second detection lines 31b are the same. In a case where the number of bus bars 2 arranged in the arrangement direction X is an odd number, the device connection unit 5 may be disposed such that the difference between the number of first detection lines 31a and the number of second detection lines 31b is not two or more.

The position of the device connection unit 5 in the arrangement direction X is not limited to the middle between the first bus bar 21 and the second bus bar 22. For example, as illustrated in FIG. 2, the position of the device connection unit 5 may be closer to the first bus bar 21 than the middle between the two bus bars 21 and 22. Conversely, the position of the device connection unit 5 may be closer to the second bus bar 22 than the middle between the two bus bars 21 and 22. The bus bar module 1 of FIG. 2 may further include a case 4 and a wiring member 7. The case 4 of the bus bar module 1 of FIG. 2 may be configured to accommodate the bus bars 2, the flexible printed circuit 3, and the wiring member 7.

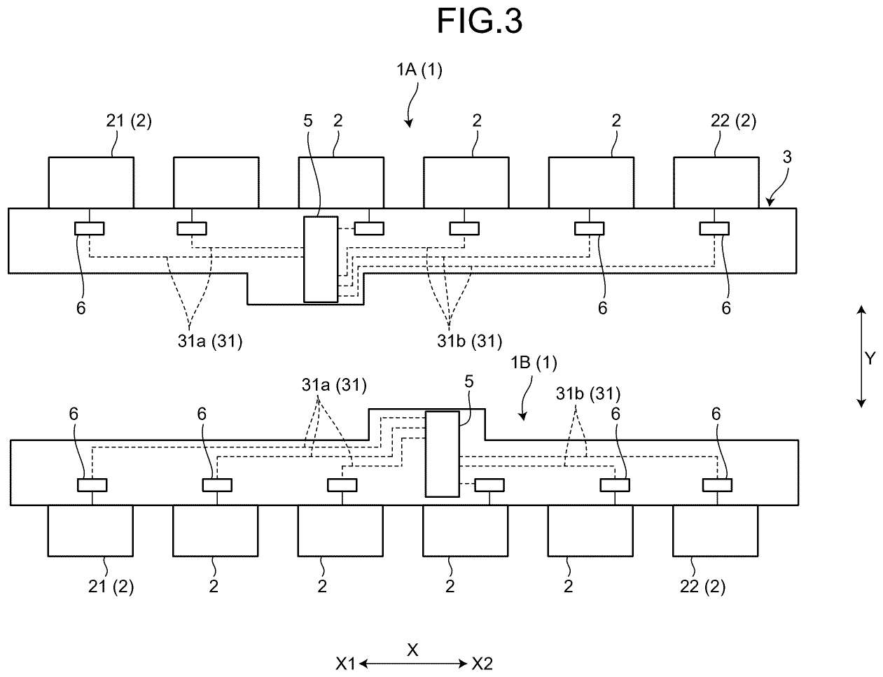

In a case where two bus bar modules 1 are arranged for one battery module, the positions of the device connection units 5 may be determined such that the two device connection units 5 do not interfere with each other. FIG. 3 illustrates a pair of bus bar modules 1. The pair of bus bar modules 1 includes a first bus bar module 1A and a second bus bar module 1B.

A bus bar 2 of the first bus bar module 1A is connected to an electrode on one side in the width direction of the battery cell. A bus bar 2 of the second bus bar module 1B is connected to an electrode on the other side in the width direction of the battery cell. In the arrangement direction X, a device connection unit 5 of the first bus bar module 1A and a device connection unit 5 of the second bus bar module 1B are shifted from each other in position. Therefore, the size in the width direction Y necessary for arranging the two bus bar modules 1A and 1B is reduced. Each of the bus bar modules 1A and 1B of FIG. 3 may have a case 4 and a wiring member 7.

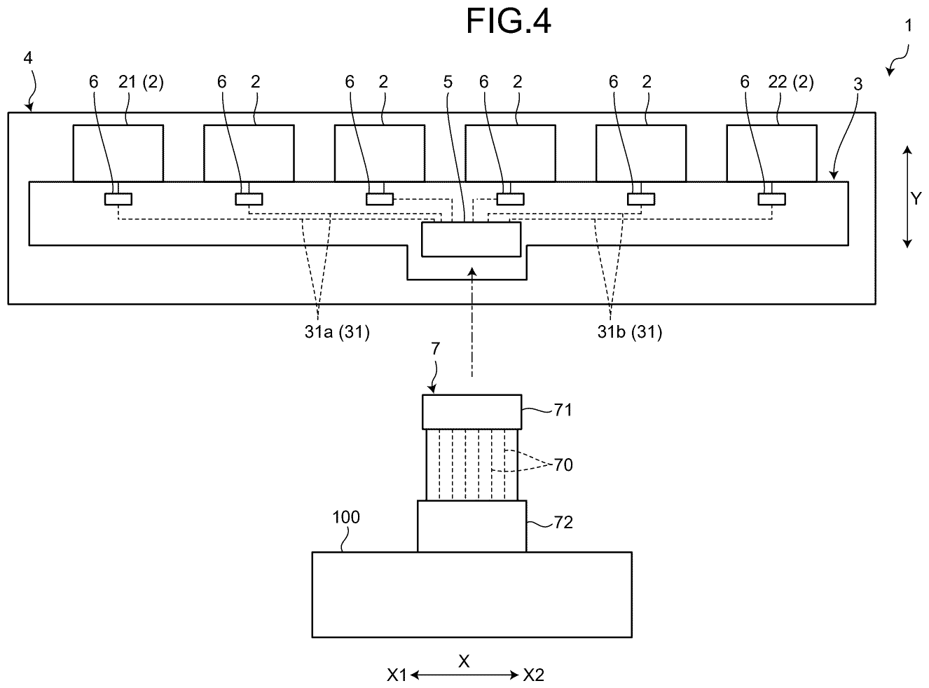

The extending direction of the wiring member 7 with respect to the device connection unit 5 is not limited to the arrangement direction X. For example, as illustrated in FIG. 4, the wiring member 7 may be drawn out in the width direction Y with respect to the device connection unit 5 and connected to the external device 100. The device connection unit 5 of FIG. 4 extends in the arrangement direction X. In a case where the device connection unit 5 is a connector, the direction in which the device connection unit 5 and the mating connector are fitted is, for example, the width direction Y. In this case, the plurality of terminals included in the device connection unit 5 are arranged, for example, in the arrangement direction X.

As described above, the bus bar module 1 of the present embodiment includes a plurality of bus bars 2 arranged in an arrangement direction X, a flexible printed circuit 3, and a device connection unit 5. The flexible printed circuit 3 includes a plurality of detection lines 31 connected to the plurality of bus bars 2. The device connection unit 5 is provided on the flexible printed circuit 3 to connect the plurality of detection lines 31 to an external device 100. A position of the device connection unit 5 in the arrangement direction X is a position between bus bars 21 and 22 at both ends. According to the bus bar module 1 of the present embodiment, the width of the flexible printed circuit 3 can be reduced.

The device connection unit 5 is positioned, for example, in the middle between the bus bars 21 and 22 at both ends in the arrangement direction X. With such a configuration, it is possible to minimize the width of the flexible printed circuit 3.

Note that the number of bus bars 2 and the number of detection lines 31 included in the bus bar module 1 are not limited to the numbers illustrated above.

The embodiments disclosed above can be carried out in an appropriate combination.

A bus bar module according to the present embodiment includes: a plurality of bus bars arranged in an arrangement direction; a flexible printed circuit including a plurality of detection lines connected to the plurality of bus bars; and a device connection unit provided on the flexible printed circuit to connect the plurality of detection lines to an external device, in which a position of the device connection unit in the arrangement direction is between bus bars at both ends. The bus bar module according to the present embodiment has an effect in that it is possible to suppress the concentration of detection lines on the flexible printed circuit and reduce the width of the flexible printed circuit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A bus bar module comprising:
a plurality of bus bars arranged in an arrangement direction;
a flexible printed circuit including a plurality of detection lines connected to the plurality of bus bars; and
a device connection unit provided on the flexible printed circuit to connect the plurality of detection lines to an external device, wherein
a position of the device connection unit in the arrangement direction is between bus bars at both ends.

2. The bus bar module according to claim 1, wherein
the device connection unit is positioned in a middle between the bus bars at both ends in the arrangement direction.
